(19) United States
(12) Patent Application Publication
(10) Pub. No.: US 2016/0339874 A1
(43) Pub. Date: Nov. 24, 2016

(54) WIPER MOTOR APPARATUS FOR VEHICLE

(71) Applicant: DY AUTO Corporation, Asan-si (KR)

(72) Inventors: Sung Jin Hong, Incheon (KR); Hwang Yong Roh, Incheon (KR)

(73) Assignee: DY AUTO Corporation, Asan-si (KR)

(21) Appl. No.: 15/089,222

(22) Filed: Apr. 1, 2016

(30) Foreign Application Priority Data
May 21, 2015 (KR) 10-2015-0071133

(51) Int. Cl. B60S 1/26

(52) U.S. Cl. CPC B60S 1/26

(57) ABSTRACT

A wiper motor apparatus for a vehicle includes a driving motor; a driving gear coupled to a driving shaft of the driving motor; a reduction gear engaged with the driving gear and having a rotation axis parallel with the driving shaft; and an output gear engaged with the reduction gear and having an output shaft parallel with the driving shaft. A magnet is disposed at a rotation center of the reduction gear. A sensor detects variations in a magnetic force of the magnet and outputs pulses according to the detected variations. The reduction gear rotates at a speed less than a speed at which the driving gear rotates. The output gear rotates at a speed less than the speed at which the reduction gear rotates.

### CROSS-REFERENCE TO RELATED APPLICATION

This application claims the benefit of Korean Patent Application No. 10-2015-0071133, filed on May 21, 2015, in the Korean Intellectual Property Office, the disclosure of which is incorporated herein in its entirety by reference.

### BACKGROUND

1. Field

One or more embodiments relate to a wiper motor apparatus for a vehicle, and more particularly, to a wiper motor apparatus for driving a reversible wiper system of a vehicle.

2. Description of the Related Art

Generally, vehicles are equipped with wiper systems to remove contaminants from glass windows. Such vehicle wiper systems are operated by reciprocally rotating wiper blades around axes by electric motors. In general, vehicle wiper systems include a pair of wiper blades connected to each other via a link device, and the pair of wiper blades are driven by a single wiper motor to wipe the windshield of a vehicle. In this case, an output shaft of the wiper motor may continuously rotate in one direction, and a link structure connected to the output shaft of the wiper motor may reciprocally rotate the wiper blades to the left and right. Recently, reversible electronic motors having an output shaft that can be rotated clockwise and anticlockwise have been increasingly used as wiper motors. Thus simple link structures or no link structures are used.

If such electronic motors capable of reciprocally rotating are used, since simple link structures or no link structures are used, simple, lightweight, and small wiper systems may be provided, thereby increasing the degree of freedom when packing components in vehicles and decreasing the manufacturing costs of vehicles.

Korean Patent Application Laid-open Publication No.: 2007-0034348 discloses an example of such electronic wiper motor apparatuses. Electronic wiper motor apparatuses basically include a reversible motor capable of rotating clockwise and anticlockwise.

A wiper driving device disclosed in the above patent application includes a driving shaft engaged with a worm wheel to reciprocally rotate a wiper arm, a magnet disposed in a center region in front of the worm wheel, and a control unit configured to detect variations in the magnetic force of the magnet and control the rotation of a motor in a clockwise or anticlockwise direction according to a result of the detection. However, since the driving shaft and the magnet are rotated at the same speed, the number of magnetic pulses per unit time detectable from the magnet by using a magnetic sensor is limited, and thus it is difficult to precisely control the driving shaft. That is, although it is necessary to detect a sufficiently large number of magnetic pulses per unit time so as to minutely detect the motion of the driving shaft, the technique disclosed in the above patent application does not allow for detection of a sufficiently large number of magnetic pulses.

### SUMMARY

One or more embodiments include a wiper motor apparatus for a vehicle, the wiper motor apparatus being configured to precisely detect a rotation speed of an output shaft and accurately control a rotation angle and speed of the output shaft.

Additional aspects will be set forth in part in the description which follows and, in part, will be apparent from the description, or may be learned by practice of the presented embodiments.

According to one or more embodiments, a wiper motor apparatus for a vehicle includes: a driving motor; a driving gear coupled to a driving shaft of the driving motor; a reduction gear engaged with the driving gear and having a rotation axis parallel with the driving shaft; and an output gear engaged with the reduction gear and having an output shaft parallel with the driving shaft, wherein a magnet is disposed at a rotation center of the reduction gear; a sensor is configured to detect variations in a magnetic force of the magnet and output pulses according to the detected variations; the reduction gear rotates at a speed less than a speed at which the driving gear rotates; the output gear rotates at a speed less than the speed at which the reduction gear rotates; the reduction gear includes a first reduction part engaged with the driving gear and a second reduction part, the second reduction part having a smaller outer diameter and fewer teeth than the first reduction part; the second reduction part is disposed at a position higher or lower than the first reduction part; and the first and second reduction parts have same rotation axis.

The driving gear, the reduction gear, and the output gear may be spur gears.

The sensor may include a Hall sensor.

The wiper motor apparatus may further include: a lower housing configured to accommodate the driving motor and having an opened upper side; and an upper housing configured to accommodate a printed circuit board on which the sensor is disposed, the upper housing being coupled to the lower housing and covering the opened upper side of the lower housing.

The output shaft may include a threaded coupling portion on a free end portion thereof for coupling with a wiper arm.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view illustrating main elements of a wiper motor apparatus for a vehicle according to an embodiment;

FIG. 2 is a perspective view illustrating a combined structure of a driving gear, a reduction gear, and an output gear of the wiper motor apparatus depicted in FIG. 1; and

FIG. 3 is a perspective view illustrating the wiper motor apparatus depicted in FIG. 1 after detaching a lower housing from the wiper motor apparatus.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

Hereinafter, embodiments will be described with reference to the accompanying drawings.

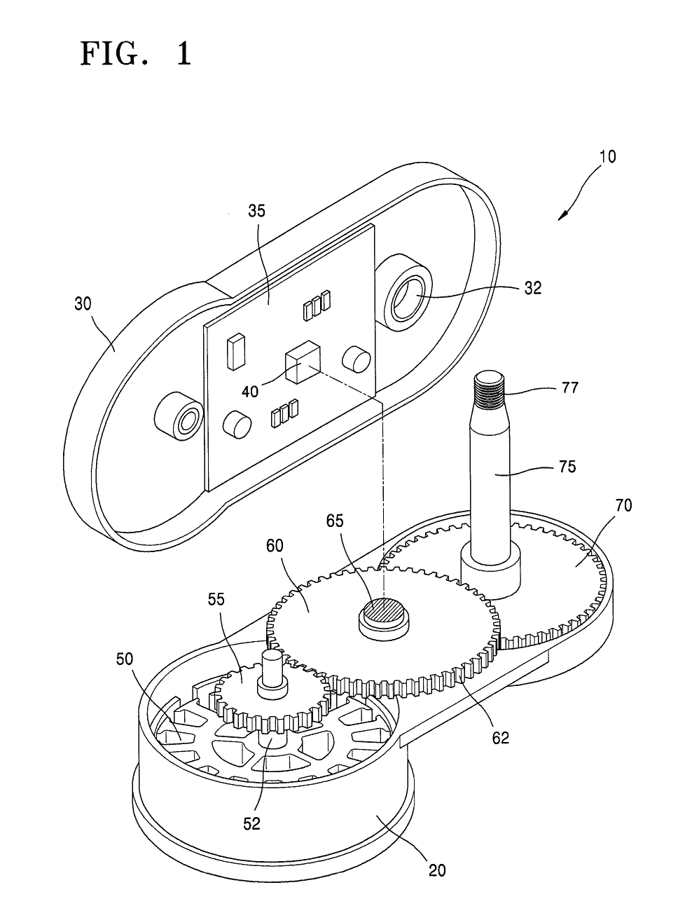

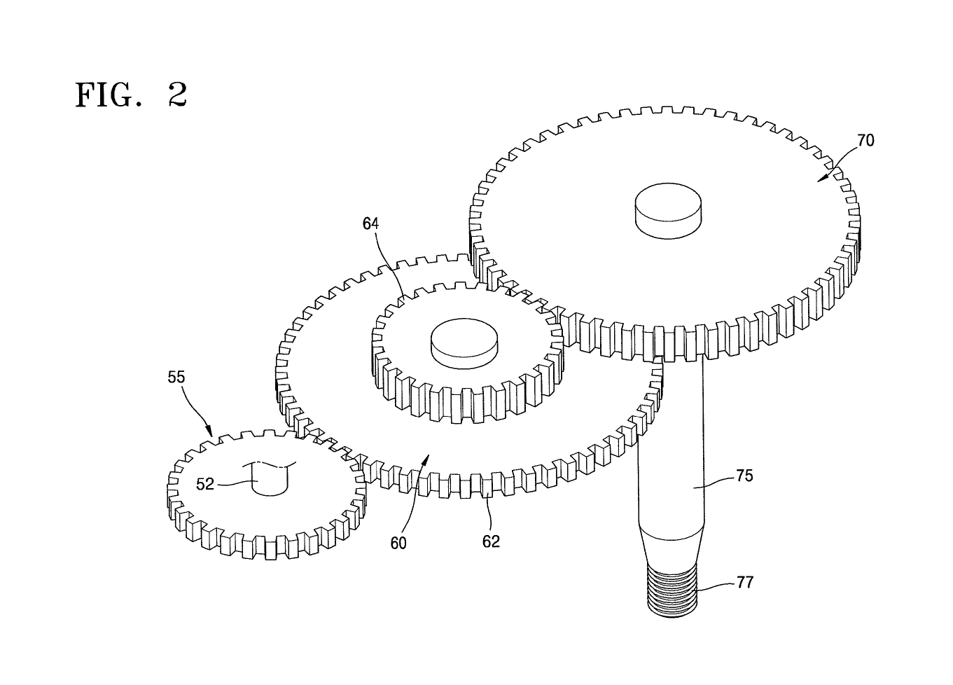

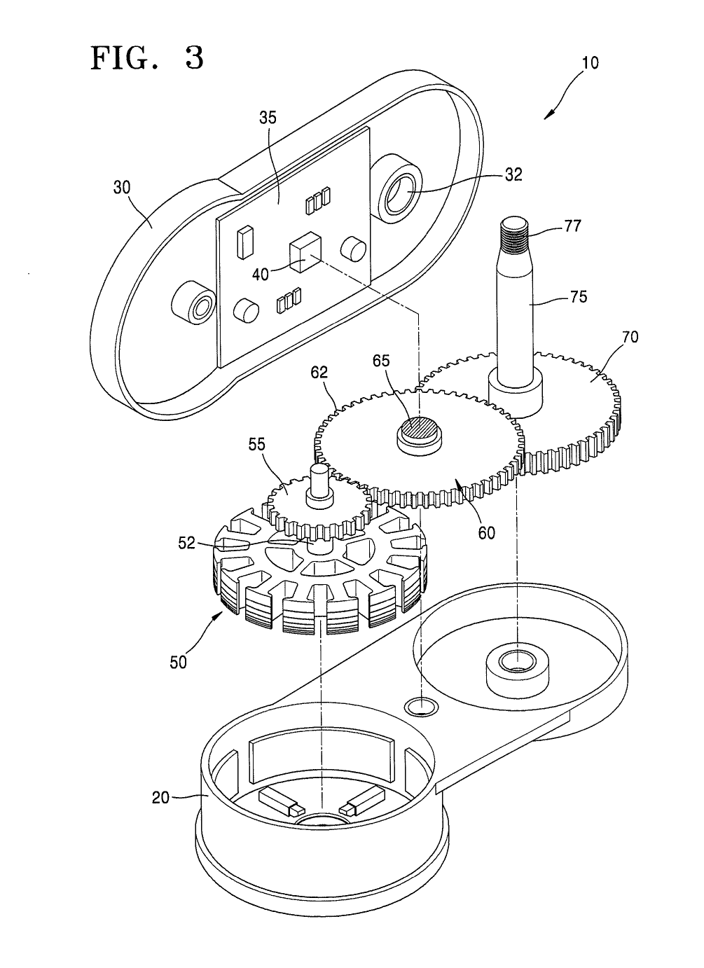

FIG. 1 is a perspective view illustrating main elements of a wiper motor apparatus 10 for a vehicle according to an embodiment. FIG. 2 is a perspective view illustrating a combined structure of a driving gear 55, a reduction gear 60, and an output gear 70 of the wiper motor apparatus 10 depicted in FIG. 1. FIG. 3 is a perspective view illustrating the wiper motor apparatus 10 depicted in FIG. 1 after detaching a lower housing 20 from the wiper motor apparatus 10.

Referring to FIGS. 1 to 3, the wiper motor apparatus 10 for a vehicle (hereinafter simply referred to as a wiper motor apparatus 10) of the embodiment is a motor apparatus for driving a wiper system configured to wipe a glass window of a vehicle.

The wiper motor apparatus 10 may include the lower housing 20, an upper housing 30, a driving motor 50, the driving gear 55, the reduction gear 60, and the output gear 70.

As described later, the lower housing 20 accommodates the driving motor 50, the driving gear 55, the reduction gear 60, and the output gear 70 while allowing for rotation thereof and has an opened upper side. The lower housing 20 may include a metallic material such as an aluminum alloy or carbon steel. Alternatively, the lower housing 20 may include a synthetic resin.

The upper housing 30 is coupled to the lower housing 20 to cover the opened upper side of the lower housing 20. The upper housing 30 includes a penetration hole 32 such that an output shaft 75 (described later) coupled to the output gear 70 may be inserted through the penetration hole 32 and may protrude outward. A printed circuit board 35 is accommodated in the upper housing 30. The printed circuit board 35 includes a circuit for applying power to the driving motor 50 (described later). A sensor 40 is disposed on the printed circuit board 35 to detect variations in the magnetic force of a magnet 65 (described later) when the magnet 65 is rotated. The sensor 40 may be disposed to face the magnet 65 (described later) with a gap therebetween. A Hall sensor may be used as the sensor 40. However, any other sensor capable of detecting magnetic force variations may be used as the sensor 40. The sensor 40 may detect variations in the magnetic force of the magnet 65 and may output a pulse signal according to the magnetic force variations.

The driving motor 50 may be a direct current (DC) motor. The lower housing 20 may function as a part of a stator of the driving motor 50. The driving motor 50 includes a driving shaft 52 configured to rotate clockwise or anticlockwise according to the direction of current applied to the driving motor 50.

The driving gear 55 is coupled to an end portion of the driving shaft 52. The driving gear 55 may be a spur gear. The driving gear 55 may be fixed to the driving shaft 52 by press fitting or using a bolt or pin. The driving gear 55 includes a teeth section having teeth formed on an outer circumferential surface of the driving gear 55 in a direction parallel with the driving shaft 52. The driving gear 55 and the driving shaft 52 are rotated together.

The reduction gear 60 is engaged with the driving gear 55. The reduction gear 60 has a rotation axis parallel with the driving shaft 52. Therefore, the reduction gear 60 rotates in a direction opposite the rotation direction of the driving gear 55. The rotation speed of the reduction gear 60 is lower than the rotation speed of the driving gear 55. The reduction gear 60 includes a first reduction part 62 and a second reduction part 64. The first reduction part 62 is formed on an outer circumferential surface of the reduction gear 60. The first reduction part 62 includes a teeth section directly engaged with the driving gear 55. The outer diameter of the first reduction part 62 is greater than the outer diameter of the driving gear 55. Therefore, the rotation speed of the reduction gear 60 is lower than the rotation speed of the driving gear 55. The second reduction part 64 is disposed at a position different from the position at which the first reduction part 62 is disposed. The second reduction part 64 may be disposed at a position higher or lower than the position at which the first reduction part 62 is disposed. In the wiper motor apparatus 10 shown in FIG. 1, the second reduction part 64 is lower than the first reduction part 62. The first reduction part 62 and the second reduction part 64 have the same rotation axis. The outer diameter of the second reduction part 64 is smaller than the outer diameter of the first reduction part 62, and the number of teeth of the second reduction part 64 is less than the number of teeth of the first reduction part 62. Both the first reduction part 62 and the second reduction part 64 are spur gears.

The magnet 65 is disposed at a rotation center of the reduction gear 60. The magnet 65 may be formed in one piece with or as an integral part of the reduction gear 60. The magnet 65 may be a permanent magnet. For example, a magnet such as a ferrite magnet or a neodymium magnet may be used as the magnet 65.

The output gear 70 is engaged with the reduction gear 60. A rotation axis of the output gear 70 is parallel with rotation axes of the reduction gear 60 and the driving gear 55. The output gear 70 is directly engaged with the second reduction part 64. The output gear 70 includes the output shaft 75 parallel with the driving shaft 52. The output shaft 75 protrudes outward through the penetration hole 32 of the upper housing 30. A threaded coupling portion 77 is formed on a free end portion of the output shaft 75. The threaded coupling portion 77 is coupled to a wiper arm (not shown). For example, an arm head of the wiper arm may be coupled to the threaded coupling portion 77.

The rotation speed of the output gear 70 is lower than the rotation speed of the reduction gear 60. That is, since the number of teeth of the first reduction part 62 is greater than the number of teeth of the driving gear 55, the rotation speed of the reduction gear 60 is lower than the rotation speed of the driving gear 55. In addition, since the number of teeth of the second reduction part 64 is less than the number of teeth of the output gear 70, the rotation speed of the output gear 70 is lower than the rotation speed of the reduction gear 60. As a result, the rotation speed of the output gear 70 is lower than the rotation speed of the driving gear 55. For example, if the rotation speed of the driving gear 55 is 60 rpm, the rotation speed of the output gear 70 may be 1 rpm.

Hereinafter, operational effects of the wiper motor apparatus 10 including the above-mentioned elements will be described.

Referring to FIG. 1, if the driving shaft 52 of the driving motor 50 rotates, the driving gear 55 is rotated together with the driving shaft 52. Since the driving gear 55 is engaged with the first reduction part 62 of the reduction gear 60, as the driving gear 55 is rotated, the reduction gear 60 is rotated at a speed less than the speed of the driving gear 55. For example, while the driving gear 55 is rotated several times or several tens of times, the reduction gear 60 may be rotated once. In addition, since the output gear 70 is engaged with the second reduction part 64 of the reduction gear 60, as the reduction gear 60 is rotated, the output gear 70 is rotated at a speed less than the speed of the reduction gear 60. For example, when the reduction gear 60 is rotated several times or several tens of times, the output gear 70 may be rotated once. The wiper arm (not shown) may be coupled to an end of the output shaft 75 of the output gear 70. In this case, when the driving gear 55 is rotated several tens of times, the wiper arm may be rotated by a predetermined angle. In addition, if the rotation direction of the driving shaft 52 of the driving motor 50 is reversed, the rotation direction of the wiper arm (not shown) coupled to the output shaft 75 may be reversed. In this manner, a wiper of a vehicle may remove contaminants from a glass window of the vehicle. In the above-mentioned process, when power is transmitted from the driving gear 55 to the output gear 70 through the reduction gear 60, the magnet 65 disposed on the rotation center of the reduction gear 60 is rotated, and thus the magnetic force (magnetic field) of the magnet 65 is varied. The sensor 40 detects variations in the magnetic force of the magnet 65 and outputs a pulse signal according to the magnetic force variations. Pulses output from the sensor 40 indicate magnetic field variations per unit time, and thus the rotation angle and speed of the reduction gear 60 may be calculated from the pulses. In addition, since the rotation angle and speed of the output gear 70 are proportional to the rotation angle and speed of the reduction gear 60, the rotation angle and speed of the output gear 70 may easily be calculated from the rotation angle and speed of the reduction gear 60. Since the rotation speed of the reduction gear 60 is greater than the rotation speed of the output gear 70, a relatively large amount of pulse data may be obtained from the reduction gear 60 compared to the case of detecting the rotation of the output gear 70. Therefore, the rotation angle and speed of the output gear 70 may be precisely measured, and the driving motor 50 may be feedback-controlled based on the measurement. As a result, the motion of the wiper arm coupled to the output shaft 75 may be more precisely controlled. Therefore, compared to sensors of wiper motor apparatuses of related art, the sensor 40 may have a relatively low degree of sensitivity, and thus the manufacturing costs of the wiper motor apparatus 10 may be decreased.

As described above, according to the one or more of the above embodiments, the rotation speed of the output gear 70 may be adjusted using the reduction gear 60 disposed in parallel with the driving gear 55. In addition, since the magnet 65 is disposed on the reduction gear 60 having a rotation speed greater than that of the output gear 70, the sensor 40 may output a relatively large number of pulses compared to the rotation angle of the output shaft 75, and thus the position of the output shaft 75 may be precisely controlled. In addition, a sensor having a low degree of sensitivity may be used as the sensor 40 to decrease the manufacturing costs of the wiper motor apparatus 10.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A wiper motor apparatus for a vehicle, the wiper motor apparatus comprising:
a driving motor;
a driving gear coupled to a driving shaft of the driving motor;
a reduction gear engaged with the driving gear and having a rotation axis parallel with the driving shaft; and
an output gear engaged with the reduction gear and having an output shaft parallel with the driving shaft,
wherein a magnet is disposed at a rotation center of the reduction gear,
a sensor is configured to detect variations in a magnetic force of the magnet and output pulses according to detected variations,
the reduction gear rotates at a speed less than a speed at which the driving gear rotates,
the output gear rotates at a speed less than the speed at which the reduction gear rotates,
the reduction gear comprises a first reduction part engaged with the driving gear and a second reduction part, the second reduction part having a smaller outer diameter and fewer teeth than the first reduction part,
the second reduction part is disposed at a position higher or lower than the first reduction part, and
the first and second reduction parts have same rotation axis.

2. The wiper motor apparatus of claim 1, wherein the driving gear, the reduction gear, and the output gear are spur gears.

3. The wiper motor apparatus of claim 1, wherein the sensor comprises a Hall sensor.

4. The wiper motor apparatus of claim 1, further comprising:
a lower housing configured to accommodate the driving motor and having an opened upper side; and
an upper housing configured to accommodate a printed circuit board on which the sensor is disposed, the upper housing being coupled to the lower housing and covering the opened upper side of the lower housing.

5. The wiper motor apparatus of claim 1, wherein the output shaft comprises a threaded coupling portion on a free end portion thereof for coupling with a wiper arm.
